(19) United States
(12) Patent Application Publication
(10) Pub. No.: US 2006/0158625 A1
(43) Pub. Date: Jul. 20, 2006

(54) Four-bar transmission mechanism

(75) Inventors: Ming-Te Cheng, Chung Ho City (TW); Chin-Chang Chiang, Chung Ho City (TW); Shi-Mu Sun, Chung Ho City (TW)

Correspondence Address: BIRCH STEWART KOLASCH & BIRCH, PO BOX 747, FALLS CHURCH, VA, 22040-0747, US

(73) Assignee: AverMedia TECHNOLOGIES, INC.

(21) Appl. No.: 11/257,063

(22) Filed: Oct. 25, 2005

(30) Foreign Application Priority Data
Jan. 14, 2005 (TW) 94101230

(51) Int. Cl. G03B 27/52

(52) U.S. Cl. 355/21

(57) ABSTRACT

A transmission mechanism that can be applied in a document camera is disclosed. The transmission mechanism includes a first roller, a second roller, a first lever and second lever. The first roller and the second roller rotate about individual axes. Ends of the first lever are pivoted about the axis of the first roller and the axis of the second roller, respectively; and ends of the second lever are pivoted about a shift point of the first roller and a shift point of the second roller, respectively. The first lever and the second lever are uncrossed.

### RELATED APPLICATIONS

The present application is based on, and claims priority from, Taiwan Application Serial Number 94101230, filed Jan. 14, 2005, the disclosure of which is hereby incorporated by reference herein in its entirety.

### BACKGROUND

1. Field of Invention

The present invention relates to a transmission mechanism. More particularly, the present invention relates to a transmission mechanism keeping a platform horizontal.

2. Description of Related Art

A conventional way of presenting information to people is by projecting slides onto a screen using an overhead projector, or employing an LCD projector to show data from a notebook computer. For some particular cases in which an enlarged image of an object is desired to explain more clearly, such as a demonstration of a living body or a circuit, a document camera is often considered. The document camera implements image transfer and provides an instantaneous enlarged image for viewers.

The rotatory lever of a conventional document camera is unable to keep a mounted platform horizontal during rotation. Moreover, when designing a four-bar transmission mechanism, a rotation range of the mechanism is a concern. If not designed well, a desired direction of rotation may not be obtainable, resulting in crossing or interference between two levers.

For the foregoing reasons, there is a need for a solution that allows a wider range of rotation of the lever and also allows the lever to rotate always in the same direction.

### SUMMARY

It is therefore an objective of the present invention to provide a transmission mechanism with a rotation range over 90 degrees.

It is another objective of the present invention to provide a transmission mechanism allowing a platform mounted on it to remain horizontal during rotation.

It is another objective of the present invention to provide a document camera whose rotatory arm is able to rotate over 90 degrees and keep a platform on it horizontal.

In accordance with the foregoing and other objectives of the present invention, a transmission mechanism is provided. A transmission mechanism includes a first roller, a second roller, a first lever and a second lever. The first roller is rotatable about an axis of the first roller, and the second roller is rotatable about an axis of the second roller.

One end of the first lever is pivoted about the axis of the first roller, and the other end is pivoted about the axis of the second roller. One end of the second lever is pivoted at a shift point of the first roller, and the other end is pivoted at a shift point of the second roller. The first lever and the second lever are uncrossed.

In another aspect, the invention is a document camera. In a preferred embodiment, the document camera includes a rotatory arm on which a platform is mounted. The rotatory arm includes a first roller, a second roller, a first lever and a second lever. The first roller is rotatable about an axis of the first roller, and the second roller is rotatable about an axis of the second roller.

One end of the first lever is pivoted about the axis of the first roller, and the other end is pivoted about the axis of the second roller. One end of the second lever is pivoted at a shift point of the first roller, and the other end is pivoted at a shift point of the second roller. The first lever and the second lever are uncrossed.

The platform is connected to the second roller and has an image capture device for image capture. During rotation of the rotatory arm about the axis of the first roller, the platform is maintained in the same orientation.

In conclusion, the transmission mechanism of the invention provides a wide rotation range of over 90 degrees and allows a platform on it to remain horizontal during rotation, so that a manual adjustment of the platform orientation is not required when the mechanism is applied in a document camera.

It is to be understood that both the foregoing general description and the following detailed description are by examples and are intended to provide further explanation of the invention as claimed.

### BRIEF DESCRIPTION OF THE DRAWINGS

These and other features, aspects and advantages of the present invention will become better understood with regard to the following description, appended claims and accompanying drawings where:

FIG. 1A is an exploded view of a transmission mechanism in accordance with a preferred embodiment of the present invention;

FIG. 1B is an exploded view of the transmission mechanism from a different perspective than in FIG. 1A;

FIG. 2 is an operation diagram of the transmission mechanism in accordance with a preferred embodiment of the present invention; and

FIG. 3 is a schematic diagram of a document camera in accordance with another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

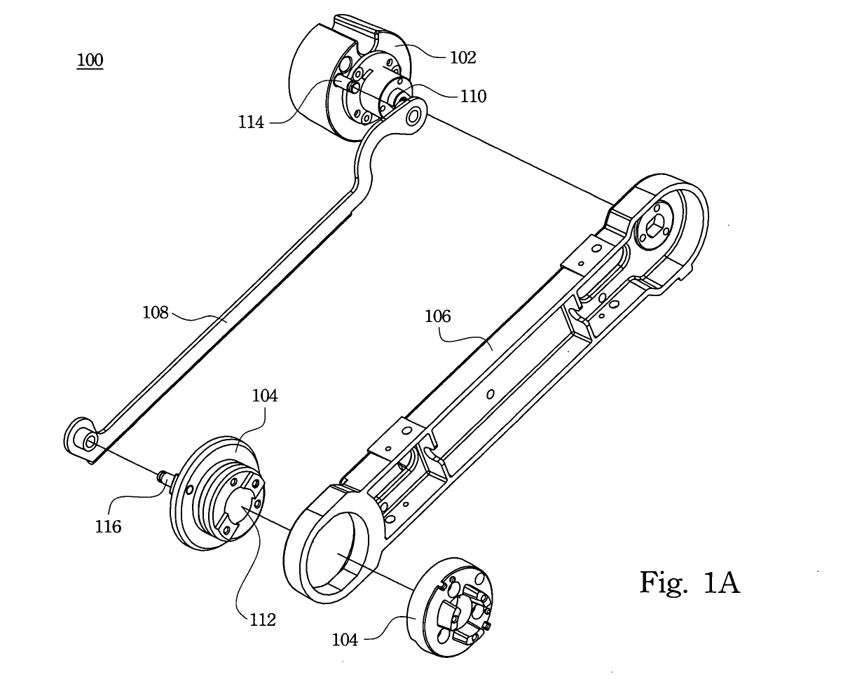

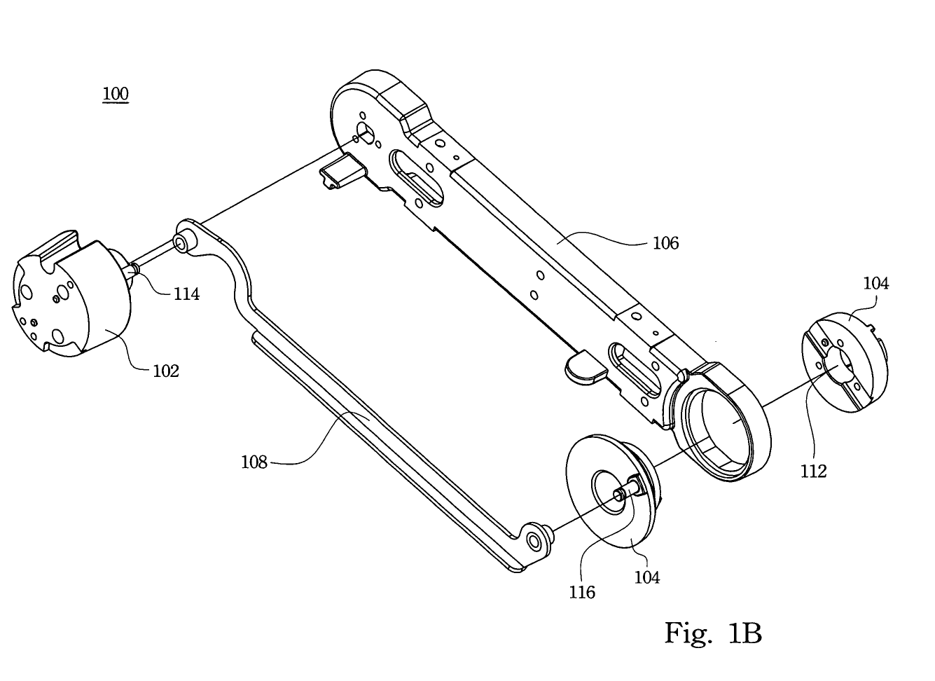

FIG. 1 is an exploded view of a transmission mechanism in accordance with a preferred embodiment of the present invention. A transmission mechanism 100 includes a first roller 102, a second roller 104, a first lever 106 and a second lever 108. The first roller 102 is rotatable about an axis 110 of the first roller 102 and the second roller 104 is rotatable about an axis 112 of the second roller 104.

The first lever 106 is pivoted about the axis 110 of the first roller 102 and an axis 112 of the second roller 104 with both ends respectively. The second lever 108 is pivotally connected to a shift point 114 of the first roller 102 and a shift point 116 of the second roller 104 with both ends respectively. Herein, the shift point means a point that is distinguished from the axis on the roller. Also, the first lever 106 and the second lever 108 are uncrossed. In one embodiment, the first lever 106 is parallel to the second lever 108. The transmission mechanism 100 is a kind of the four-bar mechanism.

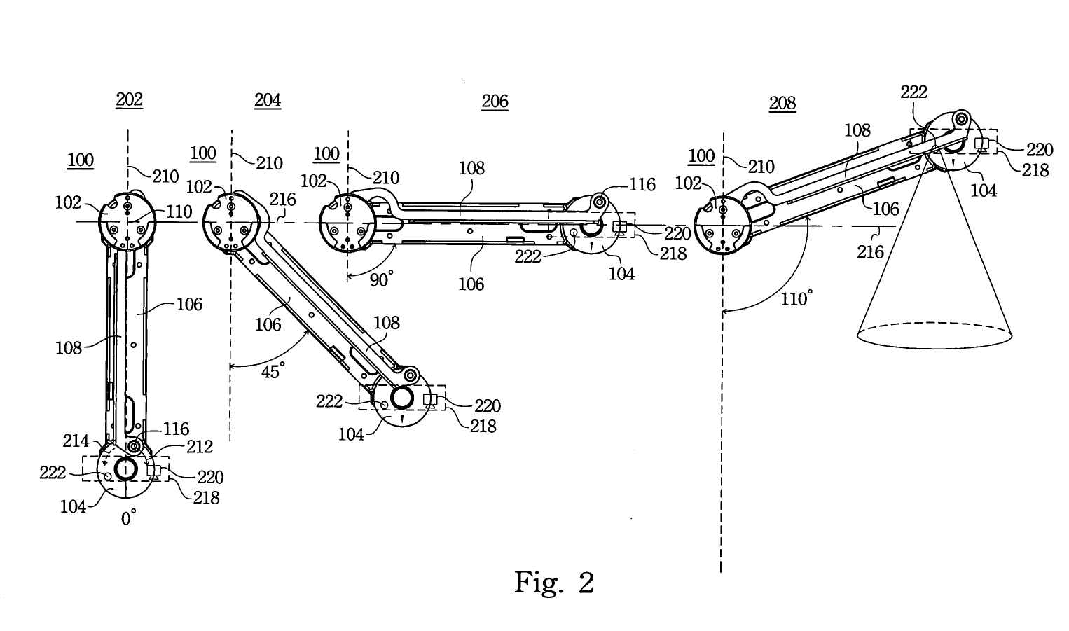

FIG. 1B is an exploded view of the transmission mechanism from a different perspective than in FIG. 1A. FIG. 2 is an operation diagram of the transmission mechanism in accordance with a preferred embodiment of the present invention. Reference is made now to FIG. 1A, FIG. 1B and FIG. 2. Motions 202-208 represent transmission mechanism 100 at different rotating angles.

When the first lever 106 is starting to rotate about the axis 110 of the first roller 102 at a starting angle of zero degrees, which is an angle between the first lever 106 and a vertical axis 210, the first lever 106 and the second lever 108 are vertical.

Then, the transmission mechanism 100 rotates to reach an angle of 45 degrees. During rotation, that is from the motion 202 to the motion 204, the second roller 104 can only rotate toward a direction 212 rather than a direction 214 due to the first lever 106 and the second lever 108 being non-coaxial. Therefore the transmission mechanism is able to limit the rotating direction of the second roller 104 so that the shift point 116 can remain on the same side with respect to the first lever 106 without moving to the opposite side.

When the transmission mechanism 100 rotates to reach an angle of 90 degrees, that is from the motion 204 to a motion 206, the first lever 106 and the second lever 108 are horizontal.

Then, the transmission mechanism 100 continues to rotate over a horizontal axis 216 that is beyond 90 degrees. In the embodiment, as a motion 208 indicates, the final rotation of the transmission mechanism 100 can reach an angle within 120 degrees, approximately 110 degrees.

The operation sequence in the embodiment above is not to limit the present invention. The transmission mechanism can rotate in any sequence within the rotation range according to user's needs. The transmission mechanism 100 can also rotate at the starting angle of any degree other than zero degrees in the embodiment.

The maximum rotating angle of the transmission mechanism 100 can be defined by changing a position about which the second lever 108 is pivoted, such as the shift point 114 or 116.

In the embodiment, the second roller 104 further includes a platform 218. When the first lever 106 rotates about the axis 110, the platform 218 remains horizontal. An image capture device 220 may be installed on the platform 218 for capturing an image of an object.

An illumination apparatus 222 can also be installed on the platform 218 for illuminating the object when the image capture device captures images.

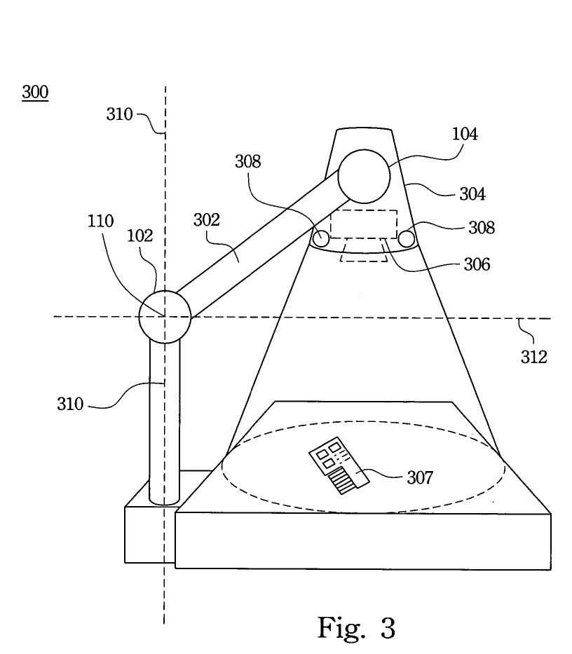

FIG. 3 is a schematic diagram of a document camera in accordance with another preferred embodiment of the present invention. A document camera 300 includes a rotatory arm 302 and a platform 304. The rotatory arm 302 is the same mechanism as the transmission mechanism in FIG. 1A and FIG. 1B.

Referring to FIGS. 1A, 1B and 3, the rotatory arm 302 includes a first roller 102, a second roller 104, a first lever 106 and a second lever 108.

One end of the first lever 106 is pivotally connected to the axis 110 of the first roller 102, and the other end is pivotally connected to the axis 112 of the second roller 104. One end of the second lever 108 is pivotally connected to the shift point 114 of the first roller 102, and the other end is pivotally connected to the shift point 116 of the second roller 104. The first lever 106 and the second lever 108 are uncrossed, and even can be parallel.

The platform 304 is connected with the second roller 104. In the embodiment, the platform includes an image capture device 306 for capturing and enlarging an image of a circuit board 307 to be displayed. During the rotation of the rotatory arm 302 with respect to the axis 110 of the first roller 102, the platform 304 remains horizontal.

In the embodiment, the platform has an illumination apparatus 308. While the image capture device 306 captures the image of the object, the illumination apparatus 308 provides illumination of the object. The rotatory arm 302 can rotate over 90 degrees (across the horizontal axis 312) starting from a vertical axis 310, as shown in the figure.

The present invention has the following advantage. The transmission mechanism and rotatory arm of a document camera in accordance with the invention are able to rotate over 90 degrees and keep the platform mounted on one side of which horizontal.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transmission mechanism, comprising:
a first roller;
a second roller;
a first lever with ends pivotally connected to an axis of the first roller and an axis of the second roller with both ends, respectively; and
a second lever with ends pivotally connected to a shift point of the first roller and a shift point of the second roller, respectively,
wherein the first lever and the second lever are uncrossed.

2. The transmission mechanism of claim 1, wherein the second roller comprises a platform, and when the first lever rotates about the axis of the first lever, the platform remains in the same orientation.

3. The transmission mechanism of claim 2, further comprising an image capture device which is mounted on the platform for capturing an image.

4. The transmission mechanism of claim 3, further comprising an illumination apparatus which is mounted on the platform for providing an illumination when the image capture device operates.

5. The transmission mechanism of claim 1, wherein the first lever and the second lever are parallel.

6. The transmission mechanism of claim 1, wherein when the first lever rotates about the axis of the first roller, a rotation range of the first lever is over 90 degrees.

7. The transmission mechanism of claim 6, wherein when the first lever starts to rotate at zero degrees, the first lever and the second lever are vertical, and when the first lever stops at an angle below 120 degrees, the first lever is across a horizontal axis.

8. A document camera, comprising:
a rotatory arm, comprising:
a first roller;
a second roller;
a first lever with ends pivotally connected to an axis of the first roller and an axis of the second roller, respectively; and
a second lever with ends pivotally connected to a shift point of the first roller and a shift point of the second roller, respectively, wherein the first lever and the second lever are uncrossed; and
a platform connected to the second roller and having an image capture device for image capture,
wherein when the rotatory arm rotates about the axis of the first lever, the platform remains horizontal.

9. The document camera of claim 8, further comprising an illumination apparatus mounted on the platform for providing an illumination when the image capture device operates.

10. The document camera of claim 8, wherein the first lever and the second lever are parallel.

11. The document camera of claim 8, wherein the first lever rotates about the axis of the first roller, and a rotation range of the first lever is over 90 degrees.

12. The document camera of claim 11, wherein when the first lever starts to rotate at zero degrees, the first lever and the second lever are vertical, and when the first lever stops at an angle below 120 degrees, the first lever is across a horizontal axis.
